(19) United States
(12) Patent Application Publication
(10) Pub. No.: US 2007/0235039 A1
(43) Pub. Date: Oct. 11, 2007

(54) Flavored mouthguard

(76) Inventor: Sheila L. Gottsch, Littleton, CO (US)

Correspondence Address: Law Offices of John S. Munday, PO BOX 423, Isanti, MN, 55040, US

(21) Appl. No.: 11/402,072

(22) Filed: Apr. 10, 2006

(51) Int. Cl. A61C 5/14

(52) U.S. Cl. 128/859

(57) ABSTRACT

A mouthguard device for use by an athlete in competition and the like, using a resilient material formed into a mouthguard and a flavor agent incorporated into the resilient material prior to formation thereof into the mouthguard. The preferred mouthguard has a two tray system that includes the flavoring agent in the tray contacting the user's taste buds. Preferred flavors are selected from citrus types such as lemon, lime, orange, and grapefruit, ginger types, berry types such as raspberry, strawberry, and blueberry, and mint types such as peppermint, spearmint, and wintergreen. Also preferred are flavoring agent includes a combination of at least two flavoring agents, and particularly wherein the combination is selected from spearmint/orange, cinnamon/clove/orange, and lemon/mint or, wherein the combination is any flavoring agent and a small amount of citrus.

### FIELD OF THE INVENTION

The present invention relates to athletic protection devices. More particularly, the invention relates to a mouthguard for athletic competition in which the mouthguard is flavored.

### BACKGROUND OF THE INVENTION

Athletes have worn protective devices for many years and such devices are constantly being refined to more fully protect the participants in sports and other athletic activities. Older persons will remember back to when professional baseball players did not wear a batting helmet because they saw the helmet as showing a weakness. Thanks to youth athletic programs, where the players had no choice but to use the equipment if they wanted to be on the team, that has changed. Now, protection is sought in many, if not all sports.

Current mouthpieces, such as athletic mouthguards, are usually formed from thermoplastic materials and come in a variety of shapes, designs, thicknesses, and sizes. Each is designed to protect a user's teeth against physical shock or blows either directly to the teeth, or against a user's jaws, head, or even the user's body. Such mouthpieces are also designed to ensure the mouthpiece stays in position and prevent bite through of the mouthpiece by the user either during normal use or upon the application of shock or blows. Such mouthpieces also may absorb, attenuate, or deflect such blows to decrease the resultant transmitted force in an attempt to decrease or minimize injury to the user.

A myriad of designs exist which attempt to reduce such injury. Such protection has been afforded by custom fitting and/or by the inclusion of ribs, bosses, chambers, inserts, devices, or by simply increasing the thickness of the mouthpiece thereby increasing its bulk. This increased bulk may also increase tongue and breathing interference with resultant discomfort to the user. Some such mouthpieces are composite designs which increase production costs and may lead to higher failure rates.

One type of mouthpiece may be made in dental offices by vacuum forming a sheet of thermoplastic material over a mold of the patient's upper or lower teeth. An example of such formed mouthpieces is PLAYSAFE™ mouthpieces by Glidewell Laboratories of Newport Beach, Calif. which use from two to three layers of laminated ethylene vinyl acetate (EVA) material to produce four different types of mouthpieces having a total thickness of from 3 mm to 5 mm. However, the PLAYSAFE™ mouthpieces are limited in their level of protection to a range of thicknesses, generally 3 mm to 5 mm, of the EVA material so as not to be uncomfortable or interfere with normal breathing or communication. They are also made of two or more layers of laminated EVA material which increase their cost.

One mouthguard that has been successful in protecting athletes is one that has a pair of trays that cooperate to provide improved protection. A first tray is provided to give structural integrity that does not deform when impacted during use. A hard form of a synthetic such as a plastic is preferred. A second tray is molded on to the first tray from a soft material, such as an ethylene vinyl acetate copolymer with a higher vinyl acetate component and is formed in a shape to contact the upper teeth of the user. This second material should have a softening temperature that is comfortable for the user, where the user can bite on the device after heating to that temperature, in hot water for example, to conform the second tray to the upper teeth.

Once the athlete begins use of the mouthguard, of whatever configuration, the portions of the mouthguard that are in intimate contact with the mouth obviously become wet with the user's saliva. Often times, especially when the athlete is young, no effort is made to clean the mouthguard after use. The dried saliva may contain bacteria or food particles and develop an odor after such a use. Then, when the athlete resumes competition, the mouthguard has an unpleasant taste.

Some athletes then try to wash the mouthguard to remove the unpleasant taste. Others have resorted to using a mint, lozenge, or chewing gum during or before using an old mouthguard. Of course it is difficult and unsafe to have other objects in one's mouth when using a mouthguard.

In one patent, Morrow et al. U.S. Pat. No. 4,537,689, the inventors noticed that a mouthguard sometimes affects the user and gives discomfort during periods of activity. Morrow et al. suggests the use of a lubricant that may, optionally, include a flavoring agent or sweetener in the lubricant composition. This is not much different from using a mint or lozenge prior to use. A mouthwash might also be considered. However, there are no mouthguard products that allow a user to simply put away the mouthguard after use, with or without washing, and use it the next time without further effort.

Accordingly, it is an advantage of the present invention to provide a mouthguard that would have a pleasant taste in the user's mouth even when the mouthguard has not been rinsed or washed after use.

Another advantage of the present invention is to provide a mouthguard with such a pleasant taste that remained in the mouthguard and did not have to be applied prior to use.

Other advantages will appear hereinafter.

### SUMMARY OF THE INVENTION

It has now been discovered that the above and other objects of the present invention may be accomplished in the following manner. Specifically, the present invention provides a mouthguard that has a flavoring agent imbedded in the polymer that forms the mouthguard prior to polymerization of the polymers or copolymers.

Various scenting and flavoring materials may be used as long as the material is compatible with the particular polymer being used to form the mouthguard. The mouthguard may have several components that combine to provide the protection, and the scenting or flavoring material should preferably be in at least the component or subcomponent that contacts the taste buds of the user. It may be simply added to the monomer prior to polymerization or it may be encapsulated in a slow release capsule that is added to the monomer before polymerization. In a preferred embodiment, the mouthguard may include gas forming materials that produce gas pockets that serve as additional cushioning. The scenting or flavoring material may or may not be incorporated in the gas pockets, as desired.

### BRIEF DESCRIPTION OF THE DRAWINGS

For a more complete understanding of the invention, reference is hereby made to the drawings, in which:

FIG. 1 is a plan view of the bottom of the preferred embodiment of the present invention;

FIG. 2 is a sectional view taken along line A-A in FIG. 1; and

FIG. 3 is a side elevational view of the device shown in FIG. 1.

### DETAILED DESCRIPTION OF THE INVENTION

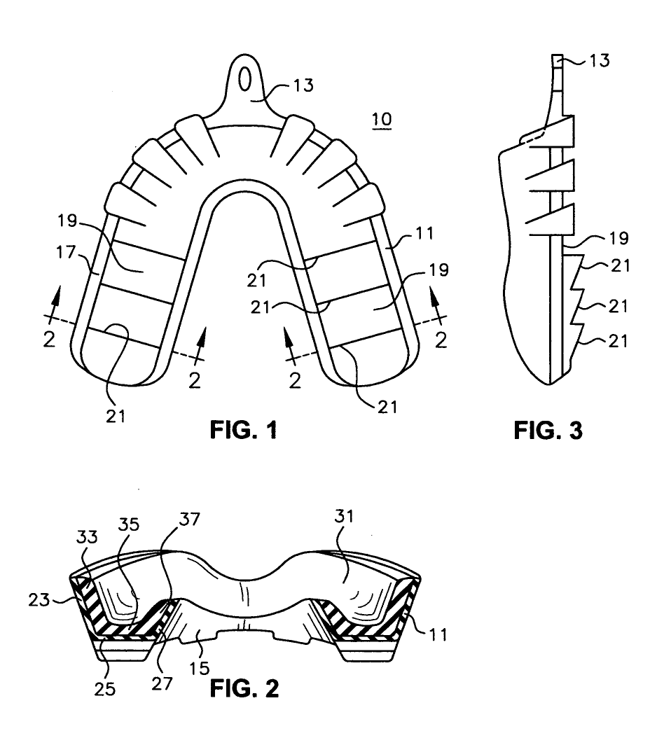

As shown in the drawings, a mouthguard in accordance with the invention, generally shown as 10, includes a first or outer tray 11, shown from the bottom in FIG. 1. First tray 11 has a tab or lip 13 for attachment to a cord or string, not shown, that can be worn around the user's neck in the conventional manner. Tray 11 has an upward facing generally U-shape such that the middle 15 of the U-shape is aligned with the front teeth and the ends 17 of the U-shape are each aligned with the back teeth. The bottom portion 19 of tray 11 along the two ends 17 includes at least one interface, shown in the drawings as ridge 21 formed on each end of sufficient size to engage at least one cusp of a lower molar of the user. The interface may be a ridge as shown, or a groove that permits the cusps on the molar to be engaged as described below. The term “interface” is defined as any raised or lowered portion of the bottom 19 that allows the cusps of the molars to engage in a manner that prevents the tray, and thus the lower jaw, from moving backward. Forward movement is not precluded. FIG. 2 illustrates the U-shape 23, 25 and 27.

The U-shape is constructed to fit the mouth of a user and engage the lower teeth. Tray 11 is of sufficient rigidity to prevent movement thereof with respect to the user's teeth upon impact, because ridges 21 engage the cusps of the molars and prevent the tray 11 from causing the mandible or lower jaw from moving back further into the mouth upon any impact to the mouth. The front 29 of the tray 11 therefore does not move. The present invention takes advantage of an instinctive reaction that a person often has, in that the person, upon anticipating a collision or other impact, will clench his or her jaw , clamping the teeth together. This instinctive reflex cooperates with the interface to further protect against backward lower jaw movement.

Fixedly attached to tray 11 is a second tray 31 that is positioned inside the U-shape 23, 25 and 27, and tray 31 also is generally U-shaped 33, 35 and 37. Second tray 31 is formed from a material having a softening point at a temperature low enough to not cause discomfort to the user, such that heating to that temperature and insertion into the user's mouth allows the user to conform said second tray 31 substantially to said upper teeth by biting down. Once the user has conformed the soft tray 31, he or she can continue to use the mouthguard without re-conforming it. In a preferred embodiment, the water will be heated to from about 130° F. to about 212° F., and preferably to between about 160° F. and 180° F., for about 30 to 60 seconds, more or less.

The first tray 11 has a thickness of about 1.0 to about 2.0 mm, and the preferred first tray 11 has a thickness of about 1.5 mm. The second tray 31 is thicker, and has a thickness of about 2.0 to about 4.0 mm, and the preferred second tray 31 has a thickness of about 3.0 mm. These dimensions have been found to provide a mouthguard that fit users comfortably without interfering with heavy breathing or swallowing saliva during use of the mouthguard. First tray 11 is preferably molded by injection molding or other conventional thermoplastic processing techniques, such as through a central tab cavity that forms tab 13. After molding first portion 11, it is placed in a second mold and that second mold is injected with a synthetic material that forms second tray 31. It is preferable to mold tray 11 first since it is harder, and then mold tray 31. It is contemplated that the first tray 11 of this invention will use a synthetic material having properties like the first two copolymers in Table I below, namely a melt index below 20, and preferably below 7, and a hardness of at least 80 and preferably 90 on the Shore A scale. Similarly the second tray of this invention will have a melt index above about 40, and preferably above 50, and a hardness of no more than about 65 and preferably about 40 on the Shore A scale. Other synthetic materials having these properties are also contemplated for use herein, as long as the material is suitably compatible with health and safety requirements for use in the mouth of a human. Because the materials have different durometer of the same EVA family of plastics, they will have a tendency to stick together when over-molded because they are of the same family of plastics.

Preferred are ethylene vinyl acetate or EVA copolymers and are available from the DuPont Company under the trade name Elvax® ethylene vinyl acetate copolymer. Elvax® is a registered trademark of the DuPont Company. Preferred Elvax® copolymers are designated with a grade designation of Elvax® 40W and Elvax® 150. Presented below is a table showing some of the properties of the preferred materials.

TABLE I

| Elvax ® Grade | Vinyl Acetate | softening point | Shore A value. |
|---|---|---|---|
| 350 | 25% | 270° F. | 80 |
| 450 | 18% | 302° F. | 90 |
| 40 W | 40% | 220° F. | 40 |
| 150 W | 33% | 230° F. | 65 |

Upon initial use, the mouthpiece is heated, preferably in warm water, to soften the first portion of the mouthpiece. The heated mouthpiece is quickly placed onto a user's teeth, again preferably against the upper teeth. The user applies suction between the jaw and mouthpiece to remove the excess moisture and air from between the mouthpiece and the teeth while gently biting down to form teeth indentations on the first portion (inner tray) of the mouthpiece, thus personalizing it to the user's specific needs. Once the mouthpiece cools, the teeth indentations remain, creating a custom fitting mouthpiece.

The flavor agent used is put into the material that forms the mouthguard prior to the polymerization of the polymer being used, so that a long term supply of the flavor will be present. The flavor agent should be placed in that portion of the mouthguard that is proximate the taste buds of the user. In the preferred embodiment described above, the flavor agent could be in the second tray that is soft and cushioning. Alternatively the flavor agent could be in both trays.

Flavor additives that may be use in this product are any flavoring agents that are pleasant in taste and are acceptable for contact with and ingestion by humans. Any of the FDA approved flavoring agents are suitable for use in this invention. Since the product pH may be designed to be slightly acidic, flavors that are accentuated by acidity would then be preferred. Some examples of these types of flavors are citrus types (lemon, lime, orange grapefruit, etc.), ginger, various berries (raspberry, strawberry, blueberry, etc.) and mint types (peppermint, spearmint, wintergreen). Interestingly, these preferred flavor types can be combined with other flavor additives to yield an acceptably flavored product. Some examples of this situation are: spearmint/orange, cinnamon/clove/orange, and lemon/mint. Often the addition of a small amount of citrus flavoring will vastly improve the overall perception of the product's taste.

While particular embodiments of the present invention have been illustrated and described, it is not intended to limit the invention, except as defined by the following claims.

1. A mouthguard device for use by an athlete in competition and the like, comprising:
a resilient material formed into a mouthguard; and
a flavor agent incorporated into said resilient material prior to formation thereof into said mouthguard.

2. The device of claim 1, wherein said resilient material is a polymeric material formed from at least one monomer, and said flavor agent is incorporated into said material prior to polymerization of said monomer.

3. The device of claim 2, wherein said polymeric material is an ethylene vinyl acetate copolymer.

4. The device of claim 1, wherein said flavoring agent is selected from citrus types such as lemon, lime, orange, and grapefruit, ginger types, berry types such as raspberry, strawberry, and blueberry, and mint types such as peppermint, spearmint, and wintergreen.

5. The device of claim 1, wherein said flavoring agent includes a combination of at least two flavoring agents.

6. The device of claim 5, wherein said combination is selected from spearmint/orange, cinnamon/clove/orange, and lemon/mint.

7. The device of claim 5, wherein said combination is any flavoring agent and a small amount of citrus.

8. A mouthguard device for use by athletes in competition and the like, comprising:
a first tray having an upward facing generally U-shape for insertion into a user's mouth such that the middle of the U-shape is aligned with the front teeth and the ends of the U-shape are aligned with the back teeth, said first tray having a lower surface with at least one interface formed on each of said ends and of sufficient size to engage at least one cusp of a lower molar of the user, said first tray being of sufficient rigidity to prevent movement thereof with respect to the user's teeth upon impact;
a second tray fixedly attached to said first tray and positioned inside said U-shape for engagement with the user's upper teeth, said second tray being formed from a material having a softening point at a temperature low enough to not cause discomfort to the user, such that heating to said temperature and insertion into the user's mouth allows the user to conform said second tray substantially to said upper teeth; and
a flavor agent incorporated into said second tray prior to formation thereof.

9. The device of claim 8, wherein first tray is molded from an ethylene vinyl acetate copolymer having a hardness of at least 80 on the Shore A scale and a softening temperature of no less than about 270° F.

10. The device of claim 9, wherein second tray is molded from an ethylene vinyl acetate copolymer having a hardness of no more than 65 on the Shore A scale and a softening temperature of no more than about 230° F.

11. The device of claim 10, wherein said first tray is about 1.0 to about 2.0 mm thick and said second tray is about 2.0 to about 4.0 mm thick.

12. The device of claim 11, wherein said flavoring agent is selected from citrus types such as lemon, lime, orange, and grapefruit, ginger types, berry types such as raspberry, strawberry, and blueberry, and mint types such as peppermint, spearmint, and wintergreen.

13. The device of claim 12, wherein said flavoring agent includes a combination of at least two flavoring agents.

14. The device of claim 13, wherein said combination is selected from spearmint/orange, cinnamon/clove/orange, and lemon/mint.

15. The device of claim 13, wherein said combination is any flavoring agent and a small amount of citrus.
